(19) United States
(12) Patent Application Publication
(10) Pub. No.: US 2026/0075170 A1
(43) Pub. Date: Mar. 12, 2026

(54) PROJECTOR

(71) Applicant: SEIKO EPSON CORPORATION, Tokyo (JP)

(72) Inventor: Takuo YONEYAMA, Azumino-shi (JP)

(21) Appl. No.: 19/323,057

(22) Filed: Sep. 9, 2025

(30) Foreign Application Priority Data
Sep. 11, 2024 (JP) 2024-157848

(51) Int. Cl. H04N 9/31; G03B 21/00

(52) U.S. Cl. CPC H04N 9/3158; G03B 21/006; H04N 9/3152; H04N 9/3161; H04N 9/3167; H04N 9/317

(57) ABSTRACT

A projector according to an aspect of the present disclosure includes a light source configured to output illumination light, a light combiner that the illumination light enters, a light modulation portion configured to modulate light incident from the light combiner to generate image modulated light, a light separation portion configured to separate the image modulated light into image generation light that is used to generate an image and image non-generation light that is not used to generate the image, a projection optical apparatus configured to project the image generation light, a light guide system configured to guide the image non-generation light incident from the light separation portion to the light combiner, and a polarization converter disposed in an optical path between the light combiner and the light modulation portion and configured to align polarization directions of the light incident from the light combiner, the illumination light being light polarized in a first polarization direction with respect to the light combiner, the image non-generation light that enters the light combiner being light polarized in a second polarization direction with respect to the light combiner, and combined with the illumination light incident from the light source in the light combiner, and caused to enter the light modulation portion.

The present application is based on, and claims priority from JP Application Serial Number 2024-157848, filed Sep. 11, 2024, the disclosure of which is hereby incorporated by reference herein in its entirety.

### BACKGROUND

### 1. Technical Field

The present disclosure relates to a projector.

### 2. Related Art

There is a projection system of related art in which the intensity of illumination light with which a display element is illuminated is increased or decreased by using a diffraction pattern such as a computer-generated hologram displayed on a spatial light modulator in accordance with the brightness of an input image (see WO 2019/215202, for example). In the projection system, light incident on dark grayscale pixels constituting an image is decreased, and light incident on bright grayscale pixels constituting the image is increased.

WO 2019/215202 is an example of the related art.

However, since the spatial light modulator used in the projection system described above uses diffraction of light, the spatial light modulator needs to have pixels the size of which is comparable to the wavelength of light and the number of which is determined in accordance with the resolution of the illumination pattern, and an enormous amount of calculation is required to create the computer-generated hologram, so that there are problems such as an increase in size of the projection system and an increase in cost thereof. Furthermore, zero-order light, a high-order diffraction image, and the like cause a diffraction loss, which causes another problem of a decrease in light use efficiency.

### SUMMARY

According to a first aspect of the present disclosure, there is provided a projector including: a light source configured to output illumination light; a light combiner that the illumination light output from the light source enters; a light modulation portion configured to modulate light incident from the light combiner to generate image modulated light; a light separation portion configured to separate the image modulated light incident from the light modulation portion into image generation light that is used to generate an image, and image non-generation light that is not used to generate the image; a projection optical apparatus configured to project the image generation light incident from the light separation portion; a light guide system configured to guide the image non-generation light incident from the light separation portion to the light combiner; and a polarization converter disposed in an optical path between the light combiner and the light modulation portion and configured to align polarization directions of the light incident from the light combiner, the illumination light output from the light source being light polarized in a first polarization direction with respect to the light combiner, and the image non-generation light caused to enter the light combiner by the light guide system being light polarized in a second polarization direction perpendicular to the first polarization direction with respect to the light combiner, combined with the illumination light incident from the light source in the light combiner, and caused to enter the light modulation portion.

### BRIEF DESCRIPTION OF THE DRAWINGS

FIG. 1 shows the configuration of key parts of a projector according to a first embodiment.

FIG. 2 shows the configuration of key parts of a projector according to a first variation.

FIG. 3 shows the configuration of key parts of a projector according to a second embodiment.

FIG. 4 shows the configuration of key parts of a projector according to a third embodiment.

FIG. 5 shows the configuration of key parts of a projector according to a second variation.

FIG. 6 is a schematic view showing the configuration of a projector according to a fourth embodiment.

FIG. 7 is a schematic view showing the configuration of a projector according to a fifth embodiment.

FIG. 8 shows the configuration of key parts of a projector according to a third variation.

### DESCRIPTION OF EMBODIMENTS

Embodiments of the present disclosure will be described below with reference to the drawings. In the drawings, elements are each drawn at a dimensional scale changed from the actual value in some cases for clarity of the element.

### First Embodiment

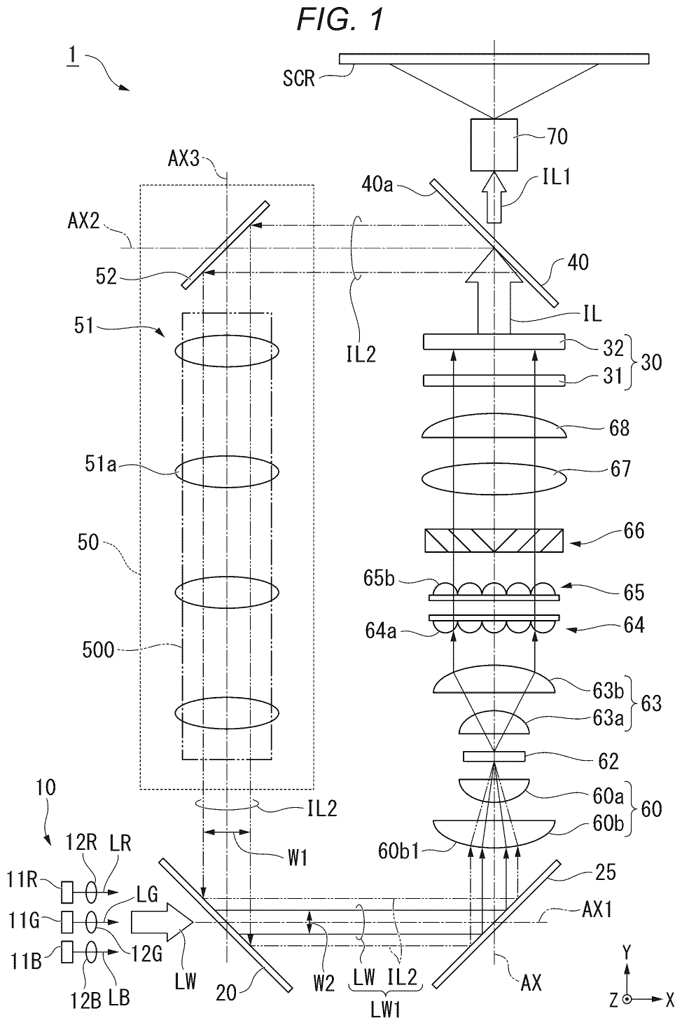

A projector according to a first embodiment of the present disclosure will first be described with reference to FIG. 1. FIG. 1 is a schematic view showing the configuration of a projector 1 according to the first embodiment.

In the following description, an XYZ coordinate system is used in some cases to describe the arrangement of the members projector 1. In the present specification, it is assumed that an X-axis is an axis along the optical axis of illumination light LW output from a light source 10, a Y-axis is an axis along the direction in which the projector 1 projects an image, and a Z-axis is an axis orthogonal to the X-axis and the Y-axis.

The projector 1 includes the light source 10, a light combiner 20, a deflector 25, a light modulation portion 30, a light separation portion 40, a light guide system 50, a first optical system 60, a diffuser 62, a second optical system 63, a first lens array 64, a second lens array 65, a polarization converter 66, a superimposing lens 67, and a projection optical apparatus 70, as shown in FIG. 1.

The projector 1 according to the present embodiment has an illumination optical axis AX, a first optical axis AX1, a second optical axis AX2, and a third optical axis AX3. The light source 10, the light combiner 20, and the deflector 25 are arranged on the first optical axis AX1. The deflector 25, the first optical system 60, the diffuser 62, the second optical system 63, the first lens array 64, the second lens array 65, the polarization converter 66, the superimposing lens 67, the light modulation portion 30, the light separation portion 40, and the projection optical apparatus 70 are arranged on the illumination optical axis AX. That is, the deflector 25, the first optical system 60, the diffuser 62, the second optical system 63, the first lens array 64, and the second lens array 65 are arranged on the optical path between the light combiner 20 and the polarization converter 66.

The light separation portion 40 and part of the light guide system 50 are arranged on the second optical axis AX2. The light guide system 50 and the light combiner 20 are arranged on the third optical axis AX3.

The light source 10 includes a first light emitter 11R, a second light emitter 11G, a third light emitter 11B, a first parallelizing element 12R, a second parallelizing element 12G, and a third parallelizing element 12B.

The first light emitter 11R is, for example, a laser diode (LD) that outputs red light LR having a red wavelength band ranging from 650 nm to 780 nm. The red light LR is linearly polarized light.

The first parallelizing element 12R parallelizes the red light LR, which is radially divergent light output from the first light emitter 11R.

The second light emitter 11G is, for example, a laser diode (LD) that outputs green light LG having a green wavelength band ranging from 520 nm to 600 nm. The green light LG is linearly polarized light.

The second parallelizing element 12G parallelizes the green light LG, which is radially divergent light output from the second light emitter 11G.

The third light emitter 11B is, for example, a laser diode (LD) that outputs blue light LB having a blue wavelength band ranging from 420 nm to 500 nm. The blue light LB is linearly polarized light.

The third parallelizing element 12B parallelizes the blue light LB, which is radially divergent light output from the third light emitter 11B.

Since the projector 1 according to the present embodiment employs a configuration that does not use diffracted light, multimode-oscillation laser light emitters can be used as the light emitters 11R, 11G, and 11B of the light source 10. The configuration described above allows suppression of generation of speckle noise while providing an intense output as compared with a configuration using single-mode-oscillation laser light emitters.

Based on the configuration described above, the light source 10 outputs the red light LR, the green light LG, and the blue light LB, which are each parallelized light, as the illumination light LW in a temporally sequential manner. Note that the numbers of the light emitters 11R, 11G, and 11B in the light source 10 are set as appropriate in accordance with the amount of light required for the multiple types of color light LR, LG, and LB from the light source 10.

The multiple types of color light LR, LG, and LB output as the illumination light LW from the light source 10 correspond to P-polarized light with respect to the light combiner 20. That is, the illumination light LW output from the light source 10 corresponds to an example of “light polarized in a first polarization direction with respect to a light combiner” in the present disclosure.

The illumination light LW output from the light source 10 is incident on the light combiner 20. The light combiner 20 is a polarization separator characterized by transmitting P-polarized light of incident light and reflecting S-polarized light of the incident light.

In the present embodiment, since the illumination light LW output from the light source 10 is P-polarized light with respect to the light combiner 20, the illumination light LW passes through the light combiner 20.

The illumination light LW having passed through the light combiner 20 is reflected off the deflector 25, and the traveling direction of the illumination light LW changes by 90 degrees. The deflector 25 is configured, for example, with a mirror. The illumination light LW reflected off the deflector 25 enters the first optical system 60. The first optical system 60 collects the light incident from the light combiner 20.

The first optical system 60: includes, for example, a first lens 60a and a second lens 60b.

In the present embodiment, the first lens 60a and the second lens 60b are each configured with a convex lens. The first optical system 60 collects the illumination light LW and causes the collected illumination light LW to enter the diffuser 62.

The diffuser 62 transmits the illumination light LW incident from the −Y side in the Y-axis direction and outputs the illumination light LW toward the +Y side with the illumination light LW diffused at a diffusion surface of the diffuser 62. The diffuser 62 is, for example, a known diffuser plate or diffuser element corresponding to color light having the visible wavelength band.

Since the illumination light LW output from the light source 10 is coherent light, speckles may be generated in a projected image. In contrast, in the present embodiment, the diffuser 62 diffuses the illumination light LW to reduce the speckle noise generated by the illumination light LW.

The second optical system 63 includes, for example, a first collimation lens 63a and a second collimation lens 63b. The second optical system 63 is a parallelizing optical system that substantially parallelizes the illumination light LW diffused by the diffuser 62. The first collimation lens 63a and the second collimation lens 63b are each configured with a convex lens. The light parallelized by the second optical system 63 enters the first lens array 64.

The first lens array 64 includes multiple first lenslets 64a, which divide the illumination light LW from the second optical system 63 into multiple sub-luminous fluxes. The multiple first lenslets 64a are arranged in a matrix in a plane perpendicular to the illumination optical axis AX.

The second lens array 65 includes multiple second lenslets 65b corresponding to the multiple first lenslets 64a of the first lens array 64. The multiple second lenslets 65b are arranged in a matrix in a plane perpendicular to the illumination optical axis AX.

The superimposing lens 67 is a lens that superimposes the light output from the second lens array 65 on the light modulation portion 30. Based on the configuration described above, the second lens array 65 along with the superimposing lens 67 superimposes images of the first lenslets 64a of the first lens array 64 in the vicinity of an image formation region of the light modulation portion 30.

The polarization converter 66 is an element that aligns the polarization directions of the light incident from the light combiner 20 with each other. Specifically, the polarization converter 66 converts the polarization directions of the light output from the second lens array 65 into a polarization direction of polarized light passing through a light-incident-side polarizer 32 of the light modulation portion 30, which will be described later. The polarization direction of the light passing through the light-incident-side polarizer 32 corresponds to S-polarized light with respect to a liquid crystal panel 31.

In the present embodiment, a field lens 68 is disposed in the optical path of the illumination light LW between the superimposing lens 67 and the light-incident-side polarizer 32. The field lens 68 parallelizes the illumination light LW to be incident on the light modulation portion 30. The illumination light LW can therefore efficiently enter the light-incident-side polarizer 32 of the light modulation portion 30.

Aligning the polarization directions of the illumination light LW with the transmission axis direction of the light-incident-side polarizer 32 by using the polarization converter 66 as described above can reduce the loss of the illumination light LW due to the light-incident-side polarizer 32 to increase the efficiency at which the illumination light LW is used.

The light modulation portion 30 in the present embodiment includes the transmissive liquid crystal panel 31 and the light-incident-side polarizer 32 provided on the light incident side of the liquid crystal panel 31. The liquid crystal panel 31 modulates the multiple types of color light LR, LG, and LB, which enter the liquid crystal panel 31 in a temporally sequential manner as the illumination light LW, based on image information input from an image input apparatus that is not shown such as a personal computer or a portable terminal device.

Based on the configuration described above, the liquid crystal panel 31 in the present embodiment outputs blue, green, or red image modulated light IL in a time division manner. The image modulated light IL output from the liquid crystal panel 31 includes image generation light IL1, which is used for image generation, and image non-generation light IL2, which is not used for image generation. That is, the image generation light IL1 corresponds to light forming bright grayscale pixels of an image, and the image non-generation light IL2 contained in the image modulated light IL corresponds to light forming dark grayscale pixels of the image.

In a typical liquid crystal panel of related art, the image non-generation light forming the dark grayscale pixels is blocked by a light-exiting-side polarizer, and the image generation light forming the bright grayscale pixels is allowed to pass through the light-exiting-side polarizer and projected onto a screen SCR as a desired image. Therefore, in the typical liquid crystal panel of related art, since the image non-generation light IL2 blocked by the light-exiting-side polarizer cannot be used as the illumination light LW, there is a problem of a decrease in the efficiency at which the illumination light LW output from the light source 10 is used.

In contrast, in the projector 1 according to the present embodiment, the efficiency at which the illumination light LW output from the light source 10 is used is increased by recycling the image non-generation light IL2, which is not used for image generation in the light modulation portion 30, as will be described later.

The configuration of recycling the image non-generation light IL2 will be specifically described below.

The image modulated light IL output from the liquid crystal panel 31 is incident on the light separation portion 40. The light separation portion 40 separates the image modulated light IL incident from the liquid crystal panel 31 into the image generation light IL1 and the image non-generation light IL2. The light separation portion 40 in the present embodiment is configured with a polarization beam splitter that transmits P-polarized light and reflects S-polarized light.

A light incident surface 40a of the light separation portion 40 is not parallel to but intersects with the optical axis of the image modulated light IL output from the light modulation portion 30. Specifically, the light separation portion 40 is disposed at an angle of 45 degrees with respect to the illumination optical axis AX.

The image generation light IL1 corresponds to P-polarized light with respect to the light separation portion 40, and the image non-generation light IL2 corresponds to S-polarized light with respect to the light separation portion 40. The liquid crystal panel 31 in the present embodiment generates the image modulated light IL by adjusting the degree of modulation of the illumination light LW, that is, the ratio between the P-polarized light and the S-polarized light in accordance with the brightness of the image generation light IL1, which passes through the light separation portion 40 and is therefore used as the image light.

Based on the configuration described above, the light separation portion 40 transmits the P-polarized light of the image modulated light IL as the image generation light IL1, and reflects the S-polarized light of the image modulated light IL as the image non-generation light IL2 in the direction along the second optical axis AX2, so that the image generation light IL1 and the image non-generation light IL2 can travel in different directions. The image generation light IL1 and the image non-generation light IL2 can therefore be favorably separated from the image modulated light IL.

The image generation light IL1 passing through the light separation portion 40 and therefore separated from the image modulated light IL enters the projection optical apparatus 70. The projection optical apparatus 70 enlarges the image generation light IL1 incident from the light separation portion 40, and projects the enlarged image generation light IL1 toward the screen SCR, which is a projection receiving surface. Note that an absorptive polarizer that transmits polarized light corresponding to the image generation light IL1 and absorbs the other polarized light may be provided at a light incident plane of the projection optical apparatus 70.

The projection optical apparatus 70 is configured, for example, with one or more optical lenses. Examples of the optical lenses may include a variety of lenses, such as a planoconvex lens, a biconvex lens, a meniscus lens, an aspherical a rod lens, and a freeform surface lens.

The image non-generation light IL2 reflected off the light separation portion 40 and therefore separated from the image modulated light IL enters the light guide system 50. The light guide system 50 guides the image non-generation light IL2 incident from the light separation portion 40 to the light combiner 20. The configuration of the light guide system 50 will be described later.

In the present embodiment, the image non-generation light IL2 caused to be incident on the light combiner 20 by the light guide system 50 is S-polarized light with respect to the light combiner 20. That is, the image non-generation light IL2 corresponds to an example of “light polarized in a second polarization direction perpendicular to the first polarization direction with respect to the light combiner” in the present disclosure.

Since the image non-generation light IL2 is S-polarized light with respect to the light combiner 20, the image non-generation light IL2 is reflected off the light combiner 20. The light combiner 20 is disposed at an angle of 45 degrees with respect to the third optical axis AX3 along the optical axis of the image non-generation light IL2. Therefore, the image non-generation light IL2 is reflected off the light combiner 20 toward the +X side and combined with the illumination light LW incident from the light source 10. The light that is the combination of the image non-generation light IL2 and the illumination light LW is hereinafter referred to as combined illumination light LW1 in some cases.

The light guide system 50 in the present embodiment includes a relay optical system 51 including multiple relay lenses 51a and a first mirror 52.

The first mirror 52 reflects the image non-generation light IL2 incident from the light separation portion 40 toward the relay optical system 51. The relay optical system 51 brings the light output from the image formation region of the light modulation portion 30, the region where the image modulated light IL is generated, into focus at the light incident surface of the first optical system 60. Note that the light incident surface of the first optical system 60 corresponds to a light incident surface 60b1 of the second lens 60b.

That is, in the present embodiment, the multiple relay lenses 51a of the relay optical system 51 are so configured that the light exiting surface of the image formation region of the light modulation portion 30 is optically conjugate with the light incident surface 60b1 of the second lens 60b. FIG. 1 shows that the relay optical system 51 includes four relay lenses 51a by way of example, but the number and arrangement of the relay lenses 51a can be changed as appropriate in accordance with the optical characteristics required for the relay optical system 51.

Using the light guide system 50 configured with the relay optical system 51 as described above allows the image non-generation light IL2, which is output from the image formation region of the light modulation portion 30 and travels via the light separation portion 40 and the light combiner 20, to efficiently enter the first optical system 60.

In the combined illumination light LW1, a luminous flux width W1 of the image non-generation light IL2 incident from the light modulation portion 30 is greater than a luminous flux width W2 of the illumination light LW output from the light source 10. The combined illumination light LW1 therefore has illuminance unevenness in which the luminance of a central portion is relatively higher than the luminance of a peripheral portion.

The combined illumination light LW1 collected by the first optical system 60 enters the diffuser 62, and the image non-generation light IL2 and the illumination light LW having the same divergent state are output from the diffuser 62. The combined illumination light LW1 diffused by the diffuser 62 therefore has a substantially fixed luminous flux width, and has a uniform illuminance distribution.

The combined illumination light LW1 enters the light modulation portion 30 via the first lens array 64, the second lens array 65, the polarization converter 66, the superimposing lens 67, and the field lens 68, as the illumination light LW described above. The image non-generation light IL2 and the illumination light LW contained in the combined illumination light LW1 have polarization directions different from each other, but the combined illumination light LW1 passes through the polarization converter 66, which aligns the polarization directions of the image non-generation light IL2 and the illumination light LW with the transmission axis direction of the light-incident-side polarizer 32. Therefore, the combined illumination light LW1 passes through the light-incident-side polarizer 32 and is favorably incident on the liquid crystal panel 31.

In addition, the combined illumination light LW1 having a uniform illuminance distribution as described above allows the liquid crystal panel 31 of the light modulation portion 30 to generate high-quality image modulated light IL without illuminance unevenness.

Part of the combined illumination light LW1 is separated as the image non-generation light IL2 by the light separation portion 40, combined with the illumination light LW output from the light source 10 in the light combiner 20, and enters the light modulation portion 30 as the combined illumination light. The cycle of the operations described above is repeated.

As described above, the projector 1 according to the present embodiment includes the light source 10, which outputs the illumination light LW, the light combiner 20, which the illumination light LW output from the light source 10 enters, the light modulation portion 30, which modulates the light incident from the light combiner 20 to generate the image modulated light IL, the light separation portion 40, which separates the image modulated light IL incident from the light modulation portion 30 into the image generation light IL1, which is used for image generation, and the image non-generation light IL2, which is not used for image generation, the projection optical apparatus 70, which projects the image generation light IL1 incident from the light separation portion 40, the light guide system 50, which guides the image non-generation light IL2 incident from the light separation portion 40 to the light combiner 20, and the polarization converter 66, which is disposed in the optical path between the light combiner 20 and the light modulation portion 30 and aligns the polarization directions of the light incident from the light combiner 20. The illumination light LW output from the light source 10 is P-polarized light with respect to the light combiner 20, and the image non-generation light IL2 caused to enter the light combiner 20 by the light guide system 50 is S-polarized light with respect to the light combiner 20. The image non-generation light IL2 is combined with the illumination light LW incident from the light source 10, and the combined light enters the light modulation portion 30.

The projector 1 according to the present embodiment allows the image non-generation light IL2, which is not used for image generation in the light modulation portion 30, to be recycled into the illumination light LW. The efficiency at which the illumination light LW output from the light source 10 is used can therefore be increased. In the present embodiment, which employs the configuration in which the image non-generation light IL2 is separated from the image modulated light IL by using the difference in the polarization direction instead of using diffraction of light, the size and the cost of the configuration of the projector 1 can be reduced as compared with those in the related art, in which a spatial light modulator is used.

In addition, diffraction loss due to zero-order light, a high-order diffraction image, and the like does not occur because diffraction of light is not used, so that the light use efficiency can be sufficiently increased.

### First Variation

Another configuration relating to the first embodiment will be subsequently described as a first variation. The present variation differs from the first embodiment in the configuration of the light separation portion. The configurations of the light separation portion and therearound will therefore be primarily described below, and the elements common to those in the drawings used in the embodiment described above have the same reference characters and will not be described.

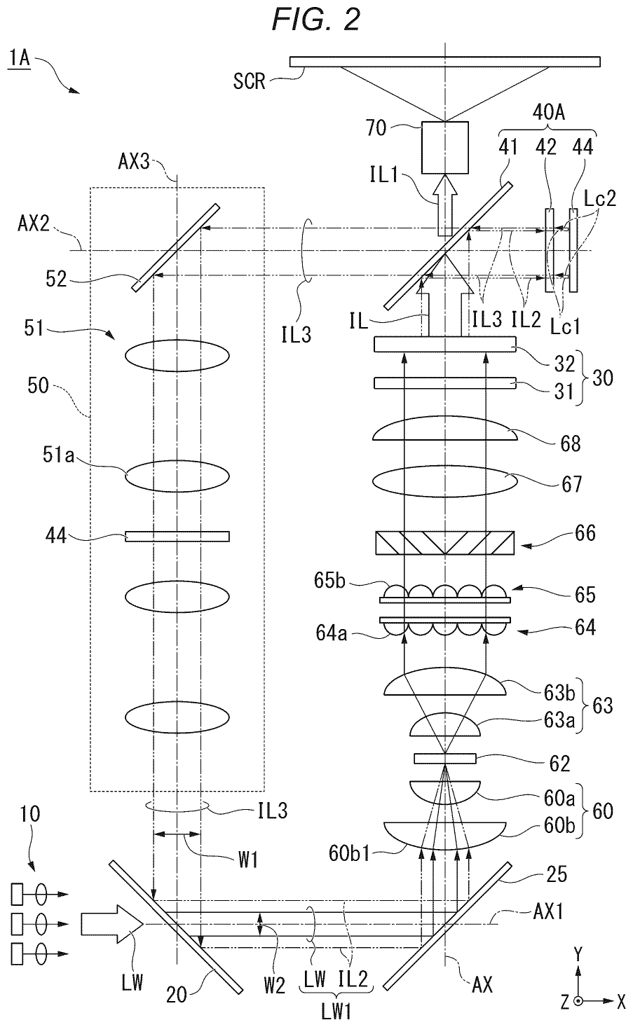

FIG. 2 shows the configuration of key parts of a projector 1A according to the present variation.

A light separation portion 40A of the projector 1A according to the present variation includes a polarization separator 41, a retarder 42, and a reflector 43, as shown in FIG. 2.

The polarization separator 41 is configured with a polarization beam splitter that transmits the image generation light IL1, which is P-polarized light, and reflects the image non-generation light IL2, which is S-polarized light. The image generation light IL1 having passed through the polarization separator 41 enters the projection optical apparatus 70 and is enlarged and projected as an image onto the screen SCR.

The polarization separator 41 reflects the image non-generation light IL2 of the image modulated light IL incident from the light modulation portion 30 toward the +X side to cause the image non-generation light IL2 to enter the retarder 42. The retarder 42 is configured with a quarter-wave plate disposed in the optical path between the polarization separator 41 and the reflector 43. The S-polarized image non-generation light IL2 reflected off the polarization separator 41 therefore enters the retarder 42. The S-polarized image non-generation light IL2 is converted, for example, into right-handed circularly polarized image non-generation light Lc1 by the retarder 42, and is then incident on the reflector 43. The reflector 43 reflects the image non-generation light Lc1 having passed through the retarder 42 toward the retarder 42. The right-handed circularly polarized image non-generation light Lc1 is reflected off the reflector 43 as left-handed circularly polarized image non-generation light Lc2.

The left-handed circularly polarized image non-generation light Lc2 is converted into P-polarized image non-generation light IL3 by the retarder 42. The P-polarized image non-generation light IL3 passes through the polarization separator 41, travels along the second optical axis AX2, and enters the light guide system 50. The image non-generation light IL3 reflected off the reflector 43 and passing through the retarder 42 thus passes through the polarization separator 41 and is separated from the image generation light IL1.

In the present embodiment, since the image non-generation light IL3 enters the light guide system 50 as P-polarized light, the image non-generation light IL3 is converted into S-polarized light with respect to the light combiner 20 by a half-wave film 44 disposed in the optical path of the light guide system 50. The light combiner 20 can thus combine the image non-generation light IL3 with the illumination light LW output from the light source 10.

Also when the light separation portion 40A in the present variation is used, the efficiency at which the illumination light LW output from the light source 10 is used can be increased by recycling the image non-generation light, which is not used for image generation, into the illumination light LW, as in the first embodiment.

### Second Embodiment

A projector according to a second embodiment of the present disclosure will be subsequently described. The basic configuration of the projector according to the second embodiment is the same as that in the first embodiment, but the configurations of the light modulation portion and the light separation portion differ from those in the first embodiment. The configurations of the light modulation portion and the light separation portion will therefore be primarily described below, and the elements common to those in the drawings used in the embodiment described above have the same reference characters and will not be described.

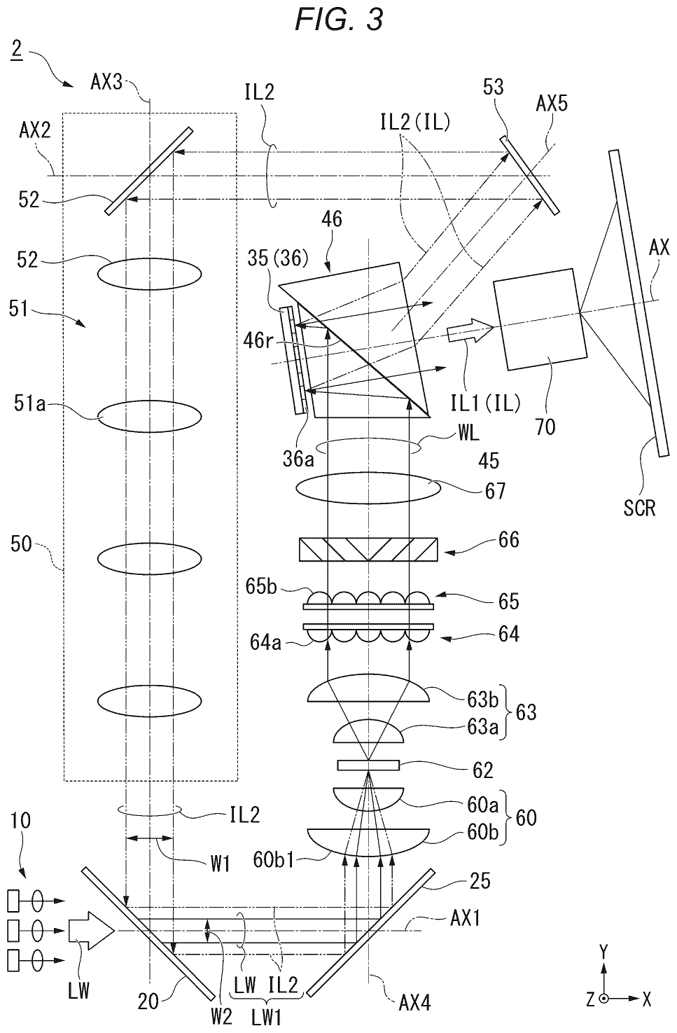

FIG. 3 is a schematic view showing the configuration of a projector 2 according to the second embodiment.

The projector 2 includes the light source 10, the light combiner 20, the deflector 25, a light modulation portion 35, a light separation portion 45, the light guide system 50, a second mirror 53, the first optical system 60, the diffuser 62, the second optical system 63, the first lens array 64, the second lens array 65, the polarization converter 66, the superimposing lens 67, and the projection optical apparatus 70, as shown in FIG. 3.

The projector 2 according to the present embodiment has the illumination optical axis AX, the first optical axis AX1, the second optical axis AX2, the third optical axis AX3, a fourth optical axis AX4, and a fifth optical axis AX5. The light source 10, the light combiner 20, and the deflector 25 are arranged on the first optical axis AX1. The deflector 25, the first optical system 60, the diffuser 62, the second optical system 63, the first lens array 64, the second lens array 65, the polarization converter 66, the superimposing lens 67, and the light separation portion 45 are arranged on the fourth optical axis AX4. The light modulation portion 35, the light separation portion 45, and the projection optical apparatus 70 are arranged on the illumination optical axis AX. The illumination optical axis AX is an axis that obliquely intersects with the fourth optical axis AX4. The light separation portion 45 and the second mirror 53 are arranged on the fifth optical axis AX5. The second mirror 53 and a portion of the light guide system 50 are arranged on the second optical axis AX2. The light guide system 50 and the light combiner 20 are arranged on the third optical axis AX3.

The light separation portion 45 in the present embodiment is configured with a prism group 46 configured with two prisms disposed so as to face each other with an air layer having a fixed thickness interposed therebetween, and has a reflection surface 46r. The angle of the reflection surface 46r is so set that the illumination light LW output from the superimposing totally reflected toward the light modulation portion 35.

The light modulation portion 35 in the present embodiment includes a micromirror-type light modulator 36. The light modulation portion 35 in the present embodiment is configured, for example, with a digital micromirror device (DMD), and includes multiple micromirrors 36a arranged in a matrix. The DMD generates the image modulated light IL in accordance with the orientation of each of the multiple micromirrors 36a. Specifically, the DMD generates the image modulated light IL containing the image generation light IL1 and the image non-generation light IL2 by switching the inclination direction of each of the multiple micromirrors 36a from one to the other. In the present embodiment, the DMD generates, in a time division manner, the image modulated light IL having a color corresponding to the illumination light LW incident from the light source 10 in a time division manner. The DMD reflects the image generation light IL1 in a direction in which the image generation light IL1 passes through the reflection surface 46r of the prism group 46 in a predetermined direction, and reflects the image non-generation light IL2 in a direction in which the image non-generation light IL2 passes through the reflection surface 46r of the prism group 46 in a direction different from the direction in which the image generation light IL1 passes.

The light separation portion 45 outputs the image generation light IL1 of the image modulated light IL incident from the light modulation portion 35 along the illumination optical axis AX by transmitting the image generation light IL1 in the direction along the illumination optical axis AX, and outputs the image non-generation light IL2 of the image modulated light IL incident from the light modulation portion 35 along the fifth optical axis AX5 by transmitting the image non-generation light IL2 in a direction different from the direction of the illumination optical axis AX.

The light separation portion 45 in the present embodiment can thus separate the image modulated light IL into the image generation light IL1 and the image non-generation light IL2 by changing the direction in which the image modulated light IL incident from the light modulation portion 35 exits.

The image generation light IL1 output from the light separation portion 45 along the illumination optical axis AX and therefore separated from the image modulated light IL enters the projection optical apparatus 70, which enlarges and projects the image generation light IL1 toward the screen SCR.

The image non-generation light IL2 output from the light separation portion 45 along the fifth optical axis AX5 and therefore separated from the image modulated light IL is incident on the second mirror 53. The second mirror 53 reflects the image non-generation light IL2 incident from the light separation portion 45 toward the light guide system 50.

In the present embodiment, the multiple relay lenses 51a of the relay optical system 51 of the light guide system 50 are so configured that the surfaces of the multiple micromirrors 36a, which are each an image formation region of the light modulation portion 35, are optically conjugate with the light incident surface 60b1 of the second lens 60b.

As described above, also in the projector 2 according to the present embodiment, the image non-generation light IL2, which is not used for image generation, can be recycled into the illumination light LW even when the light modulation portion 35 configured with the DMD is used. The efficiency at which the illumination light LW output from the light source 10 is used can therefore be increased.

Furthermore, in the projector 2 according to the present embodiment, which employs the configuration in which the image non-generation light IL2 is separated from the image modulated light IL by using the difference in the light exiting direction from the light separation portion 45 instead of using diffraction of light, the size and the cost of the configuration of the projector 2 can be reduced as compared with the related art, in which a spatial light modulator is used. In addition, diffraction loss due to zero-order light, a high-order diffraction image, and the like does not occur because diffraction of light is not used, so that the light use efficiency can be sufficiently increased.

### Third Embodiment

A projector according to a third embodiment of the present disclosure will be subsequently described. The third embodiment differs from the first embodiment in that the light modulation portion includes three liquid crystal panels, and the other basic configurations in the third embodiment are the same as those in the first embodiment. The configurations of the light modulation portion and therearound will therefore be primarily described below, and the elements common to those in the drawings used in the embodiments described above have the same reference characters and will not be described.

FIG. is a schematic view showing the configuration of a projector 3 according to the third embodiment.

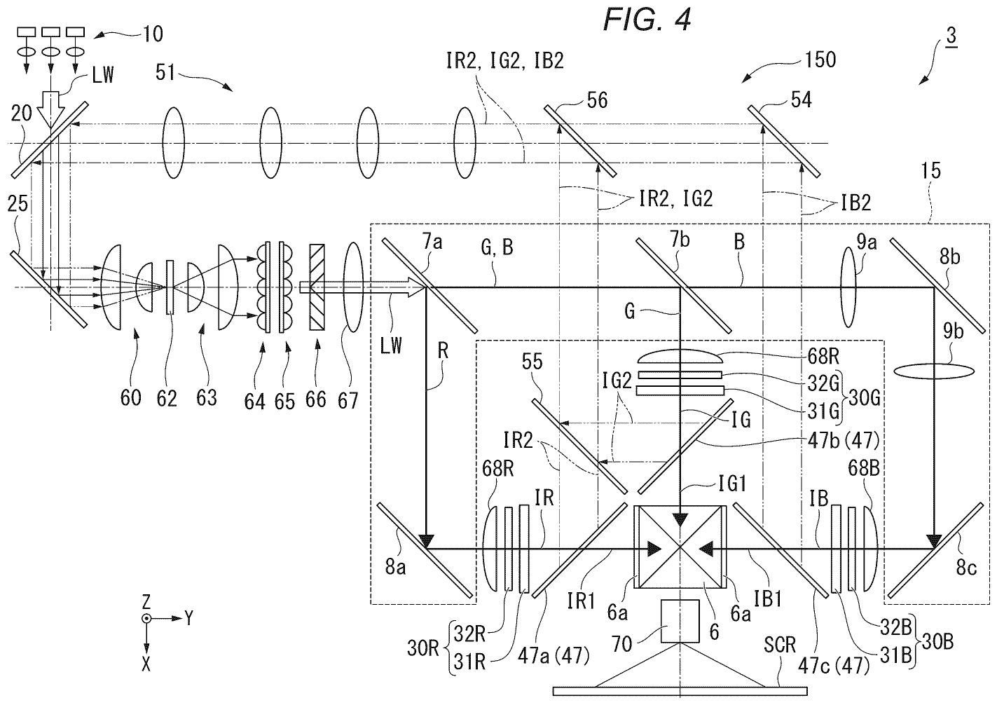

The projector 3 includes the light source 10, the light combiner 20, a light modulation portion, a light separation portion 47, a light guide system 150, the first optical system 60, the diffuser 62, the second optical system 63, the first lens array 64, the second lens array 65, the polarization converter 66, the superimposing lens 67, the projection optical apparatus 70, a color separation system 15, and a light combining system 6, as shown in FIG. 4.

In the projector 3 according to the present embodiment, the light source 10 simultaneously outputs the red light LR, the green light LG, and the blue light LB. That is, the light source 10 outputs white light containing blue light, green light, and red light as the illumination light LW.

The light modulation portion in the present embodiment includes a first light modulation portion 30R, a second light modulation portion 30G, and a third light modulation portion 30B. The first light modulation portion 30R modulates red light R of the illumination light LW to generate first image modulated light IR corresponding to the red light R. The second light modulation portion 30G modulates green light G of the illumination light LW to generate second image modulated light IG corresponding to the green light G. The third light modulation portion 30B modulates blue light B of the illumination light LW to generate third image modulated light IB corresponding to the blue light B.

In the present embodiment, the red light R corresponds to “first color light” in the present disclosure, the green light G corresponds to “second color light” in the present disclosure, and the blue light B corresponds to “third color light” in the present disclosure.

The color separation system 15 separates the white illumination light LW output from the light source 10 into the red light R, the green light G, and the blue light B. The color separation system 15 includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light LW from the light source 10 into the red light R and the other light (green light G and blue light B). The first dichroic mirror 7a transmits the red light R and reflects the other light (green light G and blue light B). The second dichroic mirror 7b reflects the green light G and transmits the blue light B to separate the other light (green light G and blue light B) into the green light G and the blue light B.

The first reflection mirror 8a is disposed in the optical path of the red light R and reflects the red light R having passed through the first dichroic mirror 7a toward the first light modulation portion 30R. The second reflection mirror 8b and the third reflection mirror 8c are disposed in the optical path of the blue light B, and guide the blue light B having passed through the second dichroic mirror 7b to the third light modulation portion 30B. The green light G is reflected off the second dichroic mirror 7b toward the second light modulation portion 30G.

The first relay lens 9a and the second relay lens 9b are disposed in the optical path of the blue light B on the light incident side and the light exiting side of the second reflection mirror 8b, respectively. The first relay lens 9a and the second relay lens 9b compensate for optical loss of the blue light B resulting from the fact that the optical path length of the blue light B is longer than the optical path lengths of the red light R and the green light G.

The first light modulation portion 30R includes a transmissive liquid crystal panel 31R and a light-incident-side polarizer 32R provided on the light incident side of the liquid crystal panel 31R.

The second light modulation portion 30G includes a transmissive liquid crystal panel 31G and a light-incident-side polarizer 32G provided on the light incident side of the liquid crystal panel 31G.

The third light modulation portion 30B includes a transmissive liquid crystal panel 31B and a light-incident-side polarizer 32B provided on the light incident side of the liquid crystal panel 31B.

A field lens 68R, a field lens 68G, and a field lens 68B are disposed on the light incident side of the first light modulation portion 30R, the second light modulation portion 30G, and the third light modulation portion 30B, respectively. The field lens 68R, the field lens 68G, and the field lens 68B parallelize the red light R, the green light G, and the blue light B to be incident on the first light modulation portion 30R, the second light modulation portion 30G, and the third light modulation portion 30B, respectively.

The light separation portion 47 includes a first light separator 47a, which separates the first image modulated light IR incident from the first light modulation portion 30R into first image generation light IR1 and first image non-generation light IR2, a second light separator 47b, which separates the second image modulated light IG incident from the second light modulation portion 30G into second image generation light IG1 and second image non-generation light IG2, and a third light separator 47c, which separates the third image modulated light IB incident from the third light modulation portion 30B into third image generation light IB1 and third image non-generation light IB2.

In the light separation portion 47 in the present embodiment, the light separators 47a, 47b, and 47c are each configured with a polarization beam splitter that transmits P-polarized light and reflects S-polarized light. The image generation light IR1, the image generation light IG1, and the image generation light IB1 correspond to P-polarized light with respect to the respective light separators, and the image non-generation light IR2, the image non-generation light IG2, and the image non-generation light IB2 correspond to S-polarized light with respect to the respective light separators.

Based on the configuration described above, the light separation portion 47 separates the image modulated light IR, IG, and IB into the image generation light and the image non-generation light by transmitting the P-polarized light of the image modulated light IR, IG, and IB as the image generation light IR1, IG1, and IB1 and reflecting the S-polarized light of the image modulated light IR, IG, and IB as the image non-generation light IR2, IG2, and IB2.

The light guide system 150 in the present embodiment includes the relay optical system 51, a first combiner 55, a second combiner 56, and a third mirror 54.

The first combiner 55 combines the first image non-generation light IR2 incident from the first light separator 47a and the second image non-generation light IG2 incident from the second light separator 47b with each other and guides the combined light to the second combiner 56. The first combiner 55 is configured with a dichroic mirror that transmits the first image non-generation light IR2 and reflects the second image non-generation light IG2.

The third mirror 54 reflects the third image non-generation light IB2 reflected off the third light separator 47c and causes the reflected light to travel toward the second combiner 56.

The second combiner 56 combines the first image non-generation light IR2 and the second image non-generation light IG2 incident from the first combiner 55 with the third image non-generation light IB2 incident from the third light separator 47c, and guides the combined light to the light combiner 20. The second combiner 56 is configured with a dichroic mirror that transmits the third image non-generation light IB2 and reflects the first image non-generation light IR2 and the second image non-generation light IG2.

The first image non-generation light IR2, the second image non-generation light IG2, and the third image non-generation light IB2 are caused by the light guide system 150 to enter the light combiner 20, which combines the three types of image non-generation light with the illumination light LW output from the light source 10.

The first image generation light IR1, the second image generation light IG1, and the third image generation light IB1 from the first light modulation portion 30R, the second light modulation portion 30G, and the third light modulation portion 30B enter the light combining system 6. The light combining system 6 outputs image light that is the combination of the first image generation light IR1, the second image generation light IG1, and the third image generation light IB1 toward the projection optical apparatus 70. The light combining system 6 is, for example, a cross dichroic prism.

In the present embodiment, retardation films 6a are provided at the light incident surfaces of the light combining system 6, which are the surfaces on which the first image generation light IR1 and the third image generation light IB1 are incident. The retardation films 6a are each a half-wave film that imparts the corresponding one of the first image generation light IR1 and the third image generation light IB1 with retardation corresponding to half of the wavelength of the light. Therefore, the first image generation light IR1 and the third image generation light IB1 pass through the retardation films 6a, which convert the two types of image generation light into S-polarized light with respect to the cross dichroic prism, and the second image generation light IG1 remains P-polarized light with respect to the cross dichroic prism. The first image generation light IR1, the second image generation light IG1, and the third image generation light IB1 are therefore favorably combined with one another by the light combining system 6, and the combined light is enlarged and projected onto the screen SCR by the projection optical apparatus 70.

As described above, the projector 3 according to the present embodiment can recycle the image non-generation light, which is not used for image generation, into the illumination light LW even when employing the three-panel structure using the three liquid crystal panels 31R, 31G, and 31B used as the light modulation portions. The efficiency at which the illumination light LW output from the light source 10 is used can therefore be increased.

Furthermore, in the projector 3 according to the present embodiment, in which the image non-generation light is separated from the image modulated light by using the difference in the light exiting direction from the light separation portion 47 instead of using diffraction of light, the size and the cost of the configuration of the projector 3 can be reduced as compared with the related art, in which a spatial light modulator is used. In addition, diffraction loss due to zero-order light, a high-order diffraction image, and the like does not occur because diffraction of light is not used, so that the light use efficiency can be sufficiently increased.

### Second Variation

Another configuration relating to the third embodiment will be subsequently described as a second variation. The present variation differs from the third embodiment in the configuration of the light guide system. The configurations of the light guide system and therearound will therefore be primarily described below, and the elements common to those in the drawings used in the embodiments described above have the same reference characters and will not be described.

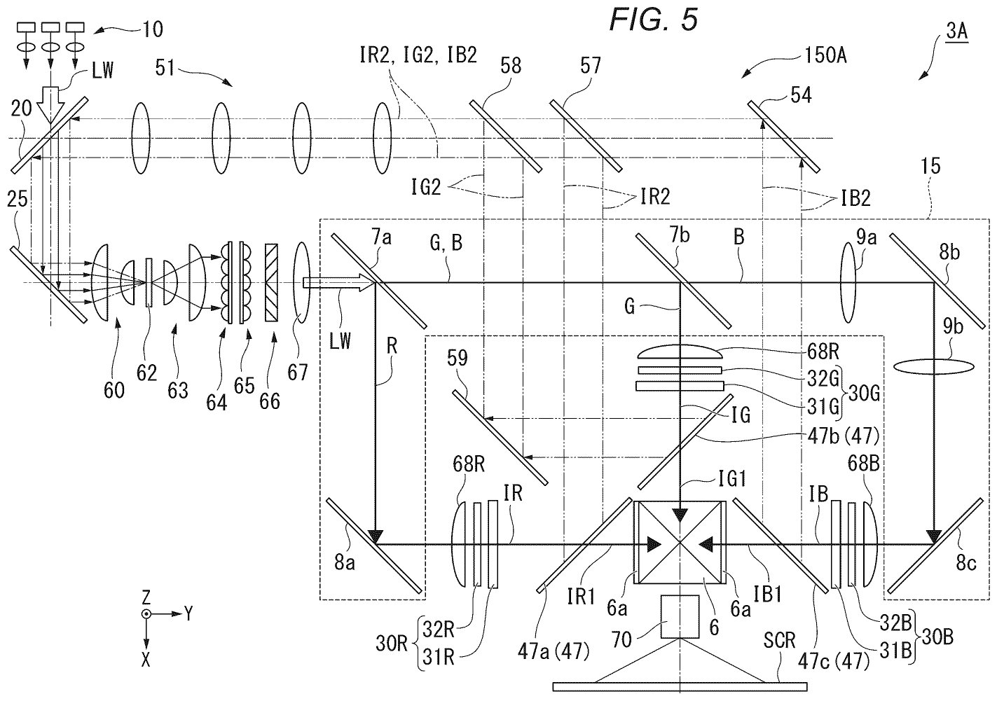

FIG. 5 shows the configuration of key parts of a projector 3A according to the present variation.

A light guide system 150A of the projector 3A according to the present variation includes the relay optical system 51, a third combiner 57, a fourth combiner 58, the third mirror 54, and a fourth mirror 59, as shown in FIG. 5.

In the present variation, the first image non-generation light IR2 separated by the first light separator 47a is incident on the third combiner 57. The second image non-generation light IG2 separated by the second light separator 47b is incident on the fourth mirror 59. The fourth mirror 59 reflects the second image non-generation light IG2 toward the fourth combiner 58.

The third mirror 54 reflects the third image non-generation light IB2 reflected off the third light separator 47c and causes the reflected light to travel toward the third combiner 57. The third combiner 57 combines the first image non-generation light IR2 and the third image non-generation light IB2 with each other and guides the combined light to the fourth combiner 58. The third combiner 57 is configured with a dichroic mirror that reflects the first image non-generation light IR2 and transmits the third image non-generation light IB2.

The fourth combiner 58 combines the first image non-generation light IR2 and the third image non-generation light IB2 incident from the third combiner 57 with the second image non-generation light IG2 incident from the fourth mirror 59, and guides the combined light to the light combiner 20. The fourth combiner 58 is configured with a dichroic mirror that transmits the first image non-generation light IR2 and the third image non-generation light IB2 and reflects the second image non-generation light IG2.

As described above, in the light guide system 150A in the present variation, instead of combining the third image non-generation light IB2 with the combined light that is the combination of the first image non-generation light IR2 and the second image non-generation light IG2 as in the light guide system 150 in the third embodiment, the second image non-generation light IG2 is combined with the combined light that is the combination of the first image non-generation light IR2 and the third image non-generation light IB2.

Also when the light guide system 150A in the present variation is used, the efficiency at which the illumination light LW output from the light source 10 is used can be increased by recycling the image non-generation light, which is not used for image generation, into the illumination light LW, as in the third embodiment.

### Fourth Embodiment

A projector according to a fourth embodiment of the present disclosure will be subsequently described. The basic configuration of the projector according to the fourth embodiment is the same as in the first embodiment, but the configuration of the light modulation portion differs from that in the first embodiment. The configuration of the light modulation portion will therefore be primarily described below, and the elements common to those in the drawings used in the embodiments described above have the same reference characters and will not be described.

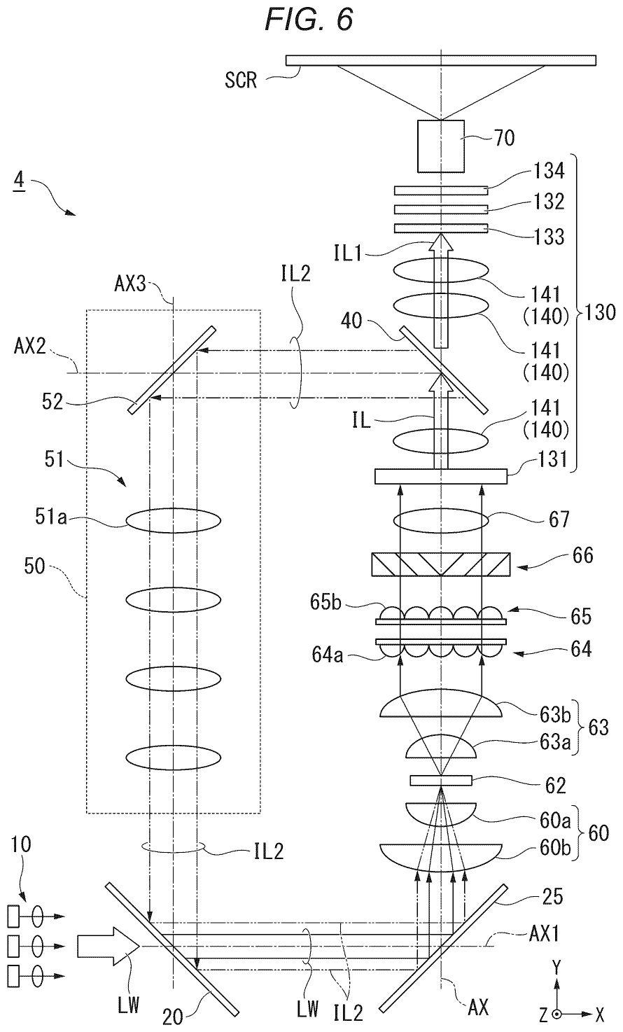

FIG. 6 is a schematic view showing the configuration of a projector 4 according to the fourth embodiment.

The projector 4 includes the light source 10, the light combiner 20, the deflector 25, a light modulation portion 130, the light separation portion 40, the light guide system 50, the first optical system 60, the diffuser 62, the second optical system 63, the first lens array 64, the second lens array 65, the polarization converter 66, the superimposing lens 67, the projection optical apparatus 70, and a relay system 140 as shown in FIG. 6.

The light modulation portion 130 in the present embodiment includes a front liquid crystal panel 131, a rear liquid crystal panel 132, a light-incident-side polarizer 133, and a light-exiting-side polarizer 134. The front liquid crystal panel 131 is located on the light incident side of the light separation portion 40. The rear liquid crystal panel 132 is located on the light exiting side of the light separation portion 40. In the present embodiment, the front liquid crystal panel 131 corresponds to a “first liquid crystal panel” in the present disclosure, and the rear liquid crystal panel 132 corresponds to a “second liquid crystal panel” in the present disclosure.

The relay system 140 includes multiple relay lenses 141. The multiple relay lenses 141 of the relay system 140 are so configured that the light exiting surface of an image formation region of the front liquid crystal panel 131 is optically conjugate with the light incident surface of an image formation region of the rear liquid crystal panel 132.

The front liquid crystal panel 131 modulates the illumination light LW incident via the superimposing lens 67 based on image information to generate the image modulated light IL. The image modulated light IL output from the front liquid crystal panel 131 includes the image generation light IL1 and the image non-generation light IL2.

The image modulated light IL output from the front liquid crystal panel 131 is incident on the light separation portion 40.

The image non-generation light IL2 reflected off the light separation portion 40 and therefore separated from the image modulated light IL enters the light guide system 50 and is combined with the illumination light LW output from the light source 10 in the light combiner 20.

The image generation light IL1 passing through the light separation portion 40 and therefore separated from the image modulated light IL enters the light-incident-side polarizer 133 via the relay system 140. The polarization direction of the image generation light IL1 having passed through the light separation portion 40 coincides with the direction along the light transmission axis of the light-incident-side polarizer 133. The image generation light IL1 therefore passes through the light-incident-side polarizer 133 and efficiently enters the rear liquid crystal panel 132. The light-exiting-side polarizer 134 is disposed on the light exiting side of the rear liquid crystal panel 132, and the light transmission axis of the light-exiting-side polarizer 134 is perpendicular to the light transmission axis of the light-incident-side polarizer 133.

The image generation light IL1 separated from the image modulated light IL in the light separation portion 40 enters the rear liquid crystal panel 132. The rear liquid crystal panel 132 modulates the image generation light IL1 based on image information to generate image light. The image light modulated by the rear liquid crystal panel 132 enters the projection optical apparatus 70 via the light-exiting-side polarizer 134 and is enlarged and projected toward the screen SCR.

In the present embodiment, it is preferable that the number of pixels of the rear liquid crystal panel 132 is greater than or equal to that of the front liquid crystal panel 131. According to the configuration described above, the efficiency at which the illumination light LW is used can be increased while the cost is suppressed as compared with a case where two high-definition liquid crystal panels are used.

As described above, in the projector 4 according to the present embodiment, since the image non-generation light IL2, which is not used for image generation in the light modulation portion 130 using the two liquid crystal panels, is recycled into the illumination light LW, the efficiency at which the illumination light LW output from the light source 10 is used can be increased.

Also in the projector 4 according to the present embodiment, in which the image non-generation light IL2 is separated from the image modulated light IL without using diffraction of light, the size and the cost of the configuration of the projector 4 can be reduced as compared with the related art, in which a spatial light modulator is used. In addition, diffraction loss due to zero-order light, a high-order diffraction image, and the like does not occur because diffraction of light is not used, so that the light use efficiency can be sufficiently increased.

### Fifth Embodiment

A projector according to a fifth embodiment of the present disclosure will be subsequently described. The basic configuration of the projector according to the fifth embodiment is substantially the same as that in the fourth embodiment. The fifth embodiment differs from the fourth embodiment in that the light modulation portion includes three liquid crystal panels and the configuration of the light separation portion is the configuration in the first variation shown in FIG. 2, and the other basic configurations in the fifth embodiment are the same as those in the fourth embodiment. The configurations of the light modulation portion, the light separation portion, and therearound will therefore be primarily described below, and the elements common to those in the drawings used in the embodiments described above have the same reference characters and will not be described.

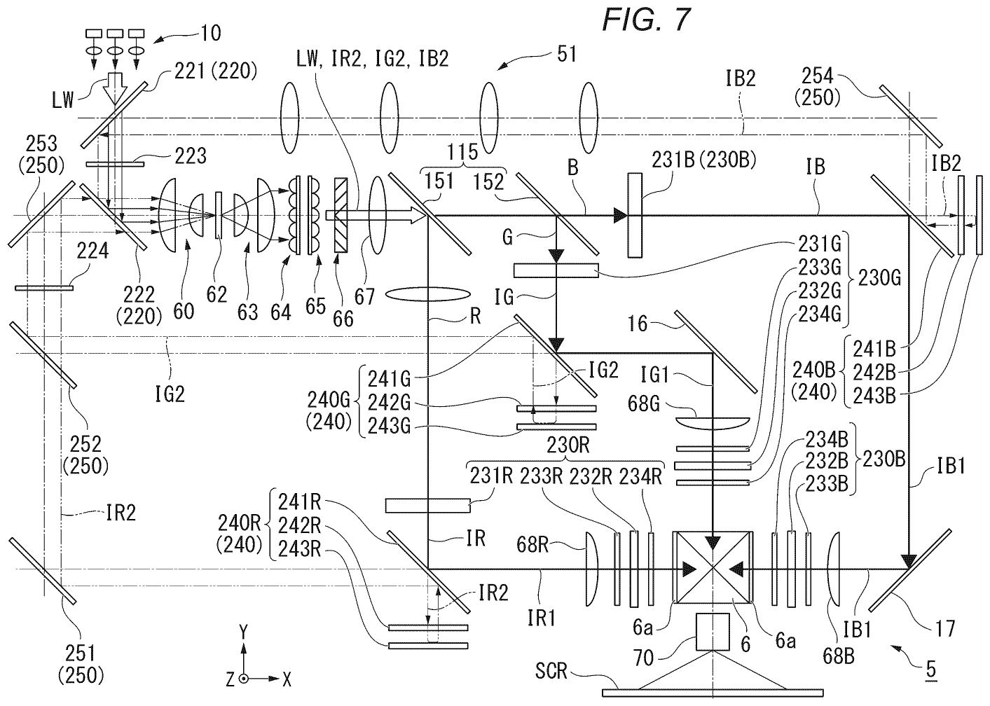

FIG. 7 is a schematic view showing the configuration of a projector 5 according to the fifth embodiment.

The projector 5 includes the light source 10, a light combiner 220, a light modulation portion, a light separation portion 240, a light guide system 250, the first optical system 60, the diffuser 62, the second optical system 63, the first lens array 64, the second lens array 65, the polarization converter 66, the superimposing lens 67, the projection optical apparatus 70, a color separation system 115, the light combining system 6, and deflection mirrors 16 and 17, as shown in FIG. 7.

In the projector 5 according to the present embodiment, the light source 10 simultaneously outputs the red light LR, the green light LG, and the blue light LB. That is, the light source 10 outputs white light as the illumination light LW.

The light combiner 220 includes a first combiner 221 and a second combiner 222.

The first combiner 221 is a polarization beam splitter that transmits the illumination light LW output from the light source 10, reflects the third image non-generation light IB2 separated from the third image modulated light IB by a third light separation portion 240B, which will be described later, and guided by the light guide system 250, and combines the illumination light LW and the third image non-generation light IB2 with each other.

The second combiner 222 is a polarization beam splitter that combines the first image non-generation light IR2 and the second image non-generation light IG2 guided by the light guide system 250 with the illumination light LW and the third image non-generation light IB2 incident from the first combiner 221, and outputs the combined light toward the light modulation portion.

In the present embodiment, a polarization converter 223, which aligns the polarization directions of the light incident from the first combiner 221 with the polarization direction of the S-polarized light with respect to the second combiner 222, is disposed between the first combiner 221 and the second combiner 222.

The light modulation portion in the present embodiment includes a first light modulation portion 230R, a second light modulation portion 230G, and a third light modulation portion 230B. The first light modulation portion 230R modulates the red light R of the illumination light LW to generate the first image modulated light IR corresponding to the red light R. The second light modulation portion 230G modulates the green light G of the illumination light LW to generate the second image modulated light IG corresponding to the green light G. The third light modulation portion 230B modulates the blue light B of the illumination light LW to generate the third image modulated light IB corresponding to the blue light B.

The color separation system 115 separates the white illumination light LW output from the light source 10 into the red light R, the green light G, and the blue light B. The color separation system 115 includes a first dichroic mirror 151 and a second dichroic mirror 152.

The first dichroic mirror 151 separates the illumination light LW from the light source 10 into the red light R, and the combination of the green light G, and the blue light B. The first dichroic mirror 151 transmits the red light R and reflects the green light G and the blue light B. The second dichroic mirror 152 reflects the green light G and transmits the blue light B to separate the green light G and the blue light B from each other.

The first light modulation portion 230R includes a front liquid crystal panel 231R, a rear liquid crystal panel 232R, a light-incident-side polarizer 233R, and a light-exiting-side polarizer 234R.

The second light modulation portion 230G includes a front liquid crystal panel 231G, a rear liquid crystal panel 232G, a light-incident-side polarizer 233G, and a light-exiting-side polarizer 234G.

The third light modulation portion 230B includes a front liquid crystal panel 231B, a rear liquid crystal panel 232B, a light-incident-side polarizer 233B, and a light-exiting-side polarizer 234B.

The front liquid crystal panel 231R modulates the red light R incident via the superimposing lens 67 based on image information to generate the image modulated light IR. The image modulated light IR output from the front liquid crystal panel 231R contains the first image generation light IR1 and the first image non-generation light IR2.

The second light modulation portion 230G and the third light modulation portion 230B have the same configuration as the first light modulation portion 230R, and will therefore not be described.

The light separation portion 240 includes a first light separation portion 240R, a second light separation portion 240G, and a third light separation portion 240B.

The first light separation portion 240R separates the first image modulated light IR incident from the front liquid crystal panel 231R of the first light modulation portion 230R into the first image generation light IR1 and the first image non-generation light IR2.

The second light separation portion 240G separates the second image modulated light IG incident from the front liquid crystal panel 231G of the second light modulation portion 230G into the second image generation light IG1 and the second image non-generation light IG2.

The third light separation portion 240B separates the third image modulated light IB incident from the front liquid crystal panel 231B of the third light modulation portion 230B into the third image generation light IB1 and the third image non-generation light IB2.

The first light separation portion 240R includes a polarization separator 241R, a retarder 242R, and a reflector 243R. The polarization separator 241R is configured with a polarization beam splitter that reflects the first image generation light IR1 incident as S-polarized light and transmits the first image non-generation light IR2 incident as P-polarized light.

The first image non-generation light IR2 having passed through the polarization separator 241R enters the retarder 242R. The retarder 242R is configured with a quarter-wave plate. The P-polarized image non-generation light IR2 passing through the polarization separator 241R is therefore converted, for example, into right-handed circularly polarized image non-generation light, and is then incident on the reflector 243R. The right-handed circularly polarized image non-generation light is reflected off the reflector 243R as left-handed circularly polarized light.

The left-handed circularly polarized image non-generation light is converted by the retarder 242R into the S-polarized image non-generation light IR2. The S-polarized image non-generation light IR2 is reflected off the polarization separator 241R and enters the light guide system 250.

The light guide system 250 includes a first light guide mirror 251, a second light guide mirror 252, a third light guide mirror 253, and a fourth light guide mirror 254.

The first light guide mirror 251 is a mirror that reflects the first image non-generation light IR2 separated by the first light separation portion 240R toward the second light guide mirror 252.

The second light guide mirror 252 is a dichroic mirror that transmits the first image non-generation light IR2 incident from the first light guide mirror 251 and reflects the second image non-generation light IG2 separated by the second light separation portion 240G toward the third light guide mirror 253 to combine the first image non-generation light IR2 and the second image non-generation light IG2 with each other.

The third light guide mirror 253 is a mirror that reflects the first image non-generation light IR2 and the second image non-generation light IG2 incident from the second light guide mirror 252 toward the second combiner 222 of the light combiner 220.

The fourth light guide mirror 254 is a mirror that reflects the third image non-generation light IB2 separated by the third light separation portion 240B toward the first combiner 221.

In the present embodiment, a retardation film 224 configured with a half-wave plate that converts the first image non-generation light IR2 and the second image non-generation light IG2 into P-polarized light with respect to the second combiner 222 is disposed between the second light guide mirror 252 and the third light guide mirror 253.

In the present embodiment, the relay optical system 51 shown in FIG. 1 may be disposed between the fourth light guide mirror 254 and the first combiner 221.

The second light separation portion 240G includes a polarization separator 241G, a retarder 242G, and a reflector 243G, and the third light separation portion 240B includes a polarization separator 241B, a retarder 242B, and a reflector 243B. Note that the second light separation portion 240G and the third light separation portion 240B have the same configuration as the first light separation portion 240R, and will therefore not be described in detail.

The light guide system 250 thus causes the first image non-generation light IR2 to enter the light combiner 220, so that the first image non-generation light IR2 is combined with the illumination light LW output from the light source 10. Similarly, the light guide system 250 causes the second image non-generation light IG2 and the third image non-generation light IB2 to enter the light combiner 220, so that the second image non-generation light IG2 and the third image non-generation light: IB2 are combined with the illumination light LW output from the light source 10.

The first image generation light IR1 reflected off the polarization separator 241R and therefore separated from the first image modulated light IR enters the light-incident-side polarizer 233R via the field lens 68R. The polarization direction of the image generation light IR1 having reflected by the polarization separator 241R of the first light separation portion 240R coincides with the direction along the light transmission axis of the light-incident-side polarizer 233R. The image generation light IR1 therefore passes through the light-incident-side polarizer 233R and efficiently enters the rear liquid crystal panel 232R. The light-exiting-side polarizer 234R is disposed on the light exiting side of the rear liquid crystal panel 232R, and the light transmission axis of the light-exiting-side polarizer 234R is perpendicular to the light transmission axis of the light-incident-side polarizer 233R.

The rear liquid crystal panel 232R modulates the image generation light IR1 based on image information to generate red image light.

In the present embodiment, the second image generation light IG1 is guided to the rear liquid crystal panel 232G of the second light modulation portion 230G with the optical path of the second image generation light IG1 deflected by the deflection mirror 16. The rear liquid crystal panel 232G modulates the second image generation light IG1 based on image information to generate green image light. The third image generation light IB1 is guided to the rear liquid crystal panel 232B of the third light modulation portion 230B with the optical path of the third image generation light IB1 deflected by the deflection mirror 17. The rear liquid crystal panel 232B modulates the third image generation light IB1 based on image information to generate blue image light.

The red image light modulated by the rear liquid crystal panel 232R enters the light combining system 6 via the light-exiting-side polarizer 234R. Similarly, the second image generation light IG1 from the second light modulation portion 230G and the third image generation light IB1 from the third light modulation portion 230B enter the light combining system 6. The light combining system 6 outputs image light that is the combination of the first image generation light IR1, the second image generation light IG1, and the third image generation light IB1 toward the projection optical apparatus 70.

As described above, the projector 5 according to the present embodiment can recycle the image non-generation light, which is not used for image generation, into the illumination light LW even when employing the structure in which the modulation portions light corresponding to three colors each use two liquid crystal panels. The efficiency at which the illumination light LW output from the light source 10 is used can therefore be increased. Also in the projector 5 according to the present embodiment, in which the image non-generation light is separated from the color image-modulated light without using diffraction of light, the size and the cost of the configuration of the projector 5 can be reduced as compared with the related art, in which a spatial light modulator is used. In addition, diffraction loss due to zero-order light, a high-order diffraction image, and the like does not occur because diffraction of light is not used, so that the light use efficiency can be sufficiently increased.

### Third Variation

Another configuration relating to the fifth embodiment will be subsequently described as a third variation. The present variation differs from the fifth embodiment in the layouts of the light source and the light combiner and in the configuration of the light guide system. The configurations of the light combiner and the light guide system will therefore be primarily described below, and the elements common to those in the drawings used in the embodiments described above have the same reference characters and will not be described.

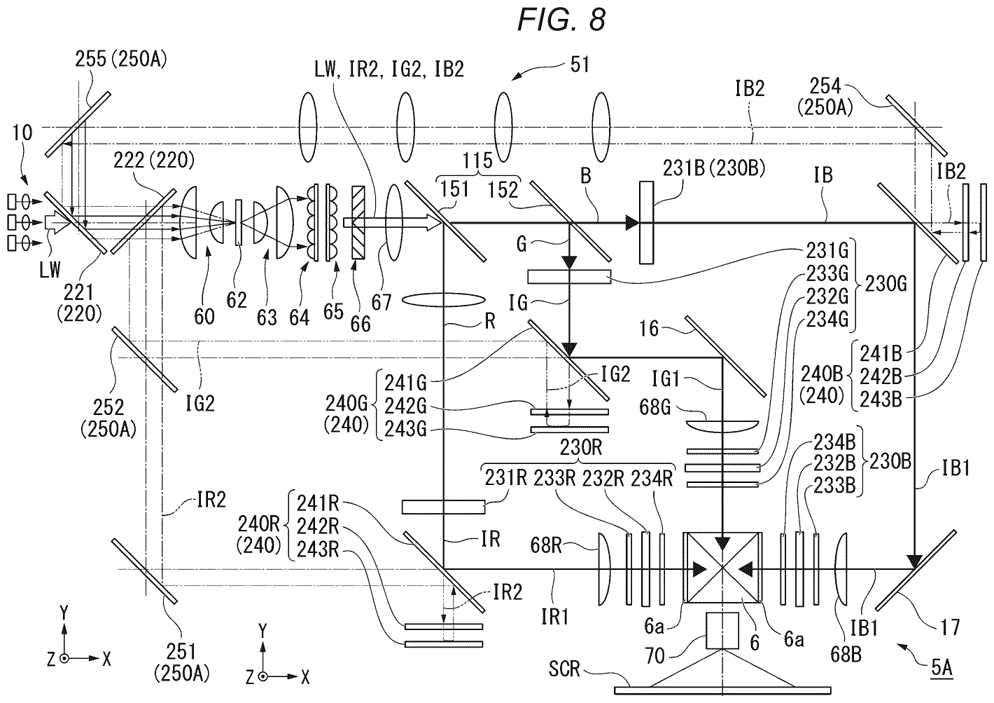

FIG. 8 shows the configuration of key parts of a projector 5A according to the present variation.

In the projector 5A according to the present variation, the light source 10 and the light combiner 220 are arranged side by side along the X-axis direction, as shown in FIG. 8. A light guide system 250A in the present variation includes the first light guide mirror 251, the second light guide mirror 252, the fourth light guide mirror 254, and a fifth light guide mirror 255.

In the present variation, the fourth light guide mirror 254 reflects the third image non-generation light IB2 separated by the third light separation portion 240B toward the fifth light guide mirror 255. The fifth light guide mirror 255 is a mirror that is disposed on the +Y side of the first combiner 221 of the light combiner 220 and reflects the third image non-generation light IB2 incident from the fourth light guide mirror 254 toward the first combiner 221.

In the present variation, the second light guide mirror 252 is disposed on the −Y side of the first combiner 221 and causes the first image non-generation light IR2 and the second image non-generation light IG2 to enter the first combiner 221.

As described above, also in the projector 5A according to the present variation, the efficiency at which the illumination light LW output from the light source 10 is used can be increased by recycling the image non-generation light, which is not used for image generation, into the illumination light LW.

Note that the technical scope of the present disclosure is not limited to the embodiments described above, and various modifications can be made thereto without departing from the intent of the present disclosure.

In addition, the specific description of the shapes, the numbers, the arrangements, the materials, and other factors of the elements of the light source apparatus and the projector are not limited to those in the embodiments described above, and can be changed as appropriate.

In the embodiments and variations described above, the diffuser 62 is a transmissive diffuser by way of example, and may instead be a reflective diffuser. In the embodiments and variations described above, the illumination light LW output from the light source 10 is P-polarized light with respect to the light combiner 20 by way of example, and may instead be S-polarized light with respect to the light combiner 20. In this case, the image non-generation light separated from the image modulated light by the light separation portion enters the light combiner 20 as P-polarized light.

In the first embodiment, the case where the light guide system 50 includes the relay optical system 51 has been presented by way of example, and the relay optical system 51 may be replaced with a rod lens 500 indicated by a two-dot chain line in FIG. 1. The rod lens 500 may have a solid structure using total reflection or a hollow structure having a space segmented by a mirror. When the thus configured rod lens 500 is used, the image non-generation light propagates while repeatedly reflected in the rod lens 500, so that the image non-generation light is allowed to have a uniform in-plane intensity distribution and exit via the light exiting surface of the rod lens 500.

The present disclosure is summarized below as additional remarks.

### Additional Remark 1

A projector including:
a light source configured to output illumination light;
a light combiner that the illumination light output from the light source enters;
a light modulation portion configured to modulate light incident from the light combiner to generate image modulated light;
a light separation portion configured to separate the image modulated light incident from the light modulation portion into image generation light that is used to generate an image, and image non-generation light that is not used to generate the image;
a projection optical apparatus configured to project the image generation light incident from the light separation portion;
a light guide system configured to guide the image non-generation light incident from the light separation portion to the light combiner; and
a polarization converter disposed in an optical path between the light combiner and the light modulation portion and configured to align polarization directions of the light incident from the light combiner,
wherein the illumination light output from the light source is light polarized in a first polarization direction with respect to the light combiner, and
the image non-generation light caused to enter the light combiner by the light guide system is light polarized in a second polarization direction perpendicular to the first polarization direction with respect to the light combiner, is combined with the illumination light incident from the light source in the light combiner, and is caused to enter the light modulation portion.

According to the thus configured projector, since the image non-generation light, which is not used for image generation in the light modulation portion, can be recycled into the illumination light, the efficiency at which the illumination light output from the light source is used can be increased.

In the case of the configuration described above, since the image non-generation light is separated from the image modulated light without using diffraction of light, the size and cost of the configuration of the projector can be reduced as compared with the related art, in which a spatial light modulator is used. In addition, diffraction loss due to zero-order light, a high-order diffraction image, and the like does not occur, so that the light use efficiency can be sufficiently increased.

### Additional Remark 2

The projector according to Additional Remark 1, wherein
a light incident surface of the light separation portion intersects with an optical axis of the image modulated light output from the light modulation portion.

According to the configuration described above, for example, transmitting the image generation light and reflecting the image non-generation light allows the image generation light and the image non-generation light to be extracted in different directions. The image non-generation light can therefore be favorably separated from the image modulated light.

### Additional Remark 3

The projector according to Additional Remark 1 or 2, further including:
a first optical system disposed in the optical path between the light combiner and the polarization converter and configured to collect the light incident from the light combiner; a diffuser that the light collected by the first optical system enters; and a second optical system configured to parallelize the light diffused by the diffuser.

According to the configuration described above, even when coherent light is used as the illumination light, speckle noise generated by the illumination light can be reduced by diffusing the coherent light with the diffuser.

### Additional Remark 4

The projector according to Additional Remark 3, further including:
a first lens array and a second lens array that the light parallelized by the second optical system enters; and a superimposing lens configured to superimpose light output from the second lens array on the light modulation portion.

According to the configuration described above, the uniformity of the illuminance distribution of the illumination light that enters the light modulation portion can be increased.

### Additional Remark 5

The projector according to Additional Remark 3 or 4, wherein
the light guide system includes a relay optical system including multiple relay lenses, and
the relay optical system is configured to bring light output from an image formation region of the light modulation portion where the image modulated light is generated into focus at a light incident surface of the first optical system.

According to the configuration described above, the image non-generation light output from the image formation region of the light modulation portion and traveling via the light separation portion and the light combiner is allowed to efficiently enter the first optical system.

### Additional Remark 6

The projector according to any one of Additional Remarks 1 to 4, wherein
the light guide system includes a rod lens.

According to the configuration described above, in which the image non-generation light propagates while repeatedly reflected in the rod lens, the image non-generation light is allowed to have a uniform in-plane intensity distribution and exit via the light exiting surface of the rod lens.

### Additional Remark 7

The projector according to any one of Additional Remarks 1 to 6, wherein
the light source includes a multimode-oscillation laser light emitter.

The configuration described above allows suppression of generation of speckle noise while providing an intense output as compared with a configuration using a single-mode-oscillation laser light emitter.

### Additional Remark 8

The projector according to any one of Additional Remarks 1 to 7, wherein
the light modulation portion includes a first light modulation portion configured to modulate first color light out of the illumination light incident from the light combiner to generate first image modulated light, and a second light modulation portion configured to modulate second color light having a wavelength band different from a wavelength band of the first color light out of the illumination light incident from the light combiner to generate second image modulated light,
the light separation portion includes a first light separator configured to separate the first image modulated light incident from the first light modulation portion into first image generation light and first image non-generation light, and a second light separator configured to separate the second image modulated light incident from the second light modulation portion into second image generation light and second image non-generation light, and
the first image non-generation light and the second image non-generation light enter the light combiner via the light guide system.

According to the configuration described above, when the two light modulation portions corresponding to the first color light and the second color light are used, the image non-generation light separated from each of the two types of image modulated light can be recycled into the illumination light.

### Additional Remark 9

The projector according to Additional Remark 8, wherein
the light modulation portion further includes a third light modulation portion configured to modulate third color light having a wavelength band different from the wavelength bands of the first color light and the second color light out of the illumination light incident from the light combiner to generate third image modulated light,
the light separation portion further includes a third light separator configured to separate the third image modulated light incident from the third light modulation portion into third image generation light and third image non-generation light,
the light guide system includes a first combiner and a second combiner,
the first combiner is configured to combine the first image non-generation light incident from the first light separator and the second image non-generation light incident from the second light separator with each other and guide the combined light to the second combiner, and
the second combiner is configured to combine the first image non-generation light and the second image non-generation light incident from the first combiner with the third image non-generation light incident from the third light separator and guide the combined light to the light combiner.

According to the configuration described above, when the three light modulation portions corresponding to the first color light, the second color light, and the third color light are used, the image non-generation light separated from each of the three types of image modulated light can be recycled into the illumination light.

### Additional Remark 10

The projector according to any one of Additional Remarks 1 to 7, wherein
the light modulation portion is configured with a micromirror-type light modulator configured to generate the image modulated light in accordance with orientation of each of multiple micromirrors, and
the light separation portion is configured to separate the image modulated light into the image generation light and the image non-generation light by changing a light exiting direction of the image modulated light incident from the light modulation portion.

According to the configuration described above, the image non-generation light, which is not used for image generation, can be recycled into the illumination light even when the micromirror-type light modulator is used.

### Additional Remark 11

The projector according to any one of Additional Remarks 1 to 7, wherein
the light modulation portion includes a first liquid crystal panel located on a light incident side of the light separation portion, and a second liquid crystal panel located on a light exiting side of the light separation portion,
the first liquid crystal panel is configured to modulate the light incident from the light combiner to generate the image modulated light, and
the image generation light separated from the image modulated light in the light separation portion enters the second liquid crystal panel.

According to the configuration described above, the efficiency at which the illumination light output from the light source is used can be increased by recycling the image non-generation light, which is not used for image generation in the light modulation portion using the two liquid crystal panels, into the illumination light.

### Additional Remark 12

The projector according to any one of Additional Remarks 1 to 9, wherein
the light separation portion includes
a polarization separator configured to reflect one of the image generation light and the image non-generation light and transmit another of the image generation light and the image non-generation light,
a retarder that the image non-generation light from the polarization separator enters, and
a reflector configured to reflect the image non-generation light passing through the retarder toward the retarder, and
the image non-generation light reflected off the reflector and passing through the retarder is separated from the image generation light when passing through the polarization separator.

According to the configuration described above, the polarization direction of the image non-generation light separated by the polarization separator can be changed by causing the image non-generation light to pass through the retarder twice. A configuration in which the image non-generation light and the image generation light are separated from each other in the polarization separator can therefore be realized.

What is claimed is:

1. A projector comprising:
a light source configured to output illumination light;
a light combiner that the illumination light output from the light source enters;
a light modulation portion configured to modulate light incident from the light combiner to generate image modulated light;
a light separation portion configured to separate the image modulated light incident from the light modulation portion into image generation light that is used to generate an image, and image non-generation light that is not used to generate the image;
a projection optical apparatus configured to project the image generation light incident from the light separation portion;
a light guide system configured to guide the image non-generation light incident from the light separation portion to the light combiner; and
a polarization converter disposed in an optical path between the light combiner and the light modulation portion and configured to align polarization directions of the light incident from the light combiner,
wherein the illumination light output from the light source is light polarized in a first polarization direction with respect to the light combiner, and
the image non-generation light caused to enter the light combiner by the light guide system is light polarized in a second polarization direction perpendicular to the first polarization direction with respect to the light combiner, is combined with the illumination light incident from the light source in the light combiner, and is caused to enter the light modulation portion.

2. The projector according to claim 1, wherein
a light incident surface of the light separation portion intersects with an optical axis of the image modulated light output from the light modulation portion.

3. The projector according to claim 1, further comprising:
a first optical system disposed in the optical path between the light combiner and the polarization converter and configured to collect the light incident from the light combiner; a diffuser that the light collected by the first optical system enters; and a second optical system configured to parallelize the light diffused by the diffuser.

4. The projector according to claim 3, further comprising:
a first lens array and a second lens array that the light parallelized by the second optical system enters; and a superimposing lens configured to superimpose light output from the second lens array on the light modulation portion.

5. The projector according to claim 3, wherein
the light guide system includes a relay optical system including multiple relay lenses, and
the relay optical system is configured to bring light output from an image formation region of the light modulation portion where the image modulated light is generated into focus at a light incident surface of the first optical system.

6. The projector according to claim 1, wherein
the light guide system includes a rod lens.

7. The projector according to claim 1, wherein
the light source includes a multimode-oscillation laser light emitter.

8. The projector according to claim 1, wherein
the light modulation portion includes a first light modulation portion configured to modulate first color light out of the illumination light incident from the light combiner to generate first image modulated light, and a second light modulation portion configured to modulate second color light having a wavelength band different from a wavelength band of the first color light out of the illumination light incident from the light combiner to generate second image modulated light,
the light separation portion includes a first light separator configured to separate the first image modulated light incident from the first light modulation portion into first image generation light and first image non-generation light, and a second light separator configured to separate the second image modulated light incident from the second light modulation portion into second image generation light and second image non-generation light, and
the first image non-generation light and the second image non-generation light enter the light combiner via the light guide system.

9. The projector according to claim 8, wherein
the light modulation portion further includes a third light modulation portion configured to modulate third color light having a wavelength band different from the wavelength bands of the first color light and the second color light out of the illumination light incident from the light combiner to generate third image modulated light,
the light separation portion further includes a third light separator configured to separate the third image modulated light incident from the third light modulation portion into third image generation light and third image non-generation light,
the light guide system includes a first combiner and a second combiner,
the first combiner is configured to combine the first image non-generation light incident from the first light separator and the second image non-generation light incident from the second light separator with each other and guide the combined light to the second combiner, and
the second combiner is configured to combine the first image non-generation light and the second image non-generation light incident from the first combiner with the third image non-generation light incident from the third light separator and guide the combined light to the light combiner.

10. The projector according to claim 1, wherein
the light modulation portion is configured with a micromirror-type light modulator configured to generate the image modulated light in accordance with orientation of each of multiple micromirrors, and
the light separation portion is configured to separate the image modulated light into the image generation light and the image non-generation light by changing a light exiting direction of the image modulated light incident from the light modulation portion.

11. The projector according to claim 1, wherein
the light modulation portion includes a first liquid crystal panel located on a light incident side of the light separation portion, and a second liquid crystal panel located on a light exiting side of the light separation portion,
the first liquid crystal panel is configured to modulate the light incident from the light combiner to generate the image modulated light, and
the image generation light separated from the image modulated light in the light separation portion enters the second liquid crystal panel.

12. The projector according to claim 1, wherein
the light separation portion includes
a polarization separator configured to reflect one of the image generation light and the image non-generation light and transmit another of the image generation light and the image non-generation light,
a retarder that the image non-generation light from the polarization separator enters, and
a reflector configured to reflect the image non-generation light passing through the retarder toward the retarder, and
the image non-generation light reflected off the reflector and passing through the retarder is separated from the image generation light when passing through the polarization separator.
